(19) United States
(12) Patent Application Publication
(10) Pub. No.: US 2017/0130402 A1
(43) Pub. Date: May 11, 2017

(54) PAPERBOARD, METHOD FOR PRODUCING THE SAME, AND IMAGE FORMING METHOD USING PAPERBOARD

(71) Applicant: FUJI XEROX Co., Ltd., Tokyo (JP)

(72) Inventors: Kojiro TSUTSUMI, Kanagawa (JP); Katsumi HARADA, Kanagawa (JP); Toshiyasu YUKAWA, Kanagawa (JP); Ryohei KIRIYAMA, Kanagawa (JP)

(73) Assignee: FUJI XEROX Co., Ltd., Tokyo (JP)

(21) Appl. No.: 15/092,782

(22) Filed: Apr. 7, 2016

(30) Foreign Application Priority Data
Nov. 5, 2015 (JP) 2015-217510

(51) Int. Cl. D21H 27/30; G03G 15/00

(52) U.S. Cl. CPC D21H 27/30; G03G 15/6582

(57) ABSTRACT

A paperboard includes plural stacked paper layers. The surface electrical resistance of an image forming surface of the paperboard in an electrophotographic system is 1×10¹³Ω or less after humidity control in an environment of 20° C. and 10% RH.

### CROSS-REFERENCE TO RELATED APPLICATIONS

This application is based on and claims priority under 35 USC 119 from Japanese Patent Application No. 2015-217510 filed Nov. 5, 2015.

### BACKGROUND

### Technical Field

The present invention relates to a multilayer paperboard and particularly to a paperboard effective in avoiding deterioration in image quality in a low-humidity environment when an image forming method with an electrophotographic system is used, a method for producing the paperboard, and an image forming method using the paperboard.

### SUMMARY

With respect to paper for a flat file, direct printing on a surface of the paper for a flat file is being enabled by using, for example, a laser printer with an electrophotographic system.

However, when a multilayer paperboard is used for the flat file, there is found a problem that particularly in a low-humidity environment, satisfactory transfer performance is not exhibited by the electrophotographic system, and deterioration in image quality easily occurs in printed products.

In addition, when a single-layer paperboard is used for the flat file, deterioration in image quality due to transfer defects is not found in printed products even if in a low-humidity environment.

According to an aspect of the invention, there is provided a paperboard including plural stacked paper layers, wherein the surface electrical resistance of an image forming surface with an electrophotographic system is 1×10¹³Ω or less after humidity control in an environment of 20° C. and 10% RH.

### BRIEF DESCRIPTION OF THE DRAWINGS

Exemplary embodiments of the present invention will be described in detail based on the following figures, wherein:

FIG. 1A is an explanatory view showing an outline of an image forming method using a paperboard according to an exemplary embodiment to which the present invention is applied;

FIG. 1B is an explanatory view showing the outline of a paperboard according to an exemplary embodiment to which the present invention is applied;

FIG. 1C is an explanatory view showing an outline of a method for producing a paperboard according to an exemplary embodiment to the present invention is applied;

FIG. 2 is an explanatory view showing a flat file using a paperboard according to an exemplary embodiment of the present invention;

FIG. 3A is an explanatory plan view of the flat file shown in FIG. 2;

FIG. 3B is a cross-sectional view of the flat file taken along line IIIB-IIIB in FIG. 3A;

FIG. 4A is an explanatory cross-sectional view in the thickness direction of a paperboard used as a cover of a flat file according to an exemplary embodiment of the present invention;

FIG. 4B is an explanatory view showing a state in which each of layers of a paperboard is separated from each other;

FIG. 5A is an explanatory view showing an example of a method for producing a paperboard used as a front cover of a flat file according to an exemplary embodiment of the present invention;

FIG. 5B is an explanatory view schematically showing coating with a conductive agent in an example of a method for producing a paperboard;

FIG. 6 is an explanatory view showing an example of an image forming method using a flat file according to an exemplary embodiment of the present invention;

FIG. 7 is a graph showing a relation between the equilibrium moisture content and surface electrical resistance of a paperboard or paper in each of Example 1 and Comparative Examples 1 to 3;

FIG. 8 is a graph showing a relation between the toner density and surface electrical resistance as results of image formation using a paperboard or paper in each of Example 1 and Comparative Examples 1 to 3;

FIG. 9A is an explanatory cross-sectional view in the thickness direction of a paperboard according to Comparative Example 1;

FIG. 9B is an enlarged explanatory view of FIG. 9A;

FIG. 10 is an explanatory view showing the physical properties, characteristics, and image quality evaluation of paperboards according to Examples 1 to 4 and Comparative Examples 1 to 3;

FIG. 11A is an explanatory view showing an example of image quality evaluation (using a halftone secondary-color image sample) by an electrophotographic system using paperboards according to Examples 1 and 2 and Comparative Example 1;

FIG. 11B is a graph showing changes in image density with the passage of standing time; and

FIG. 12 is an explanatory view showing an example of image quality evaluation (using a full-color image sample) by an electrophotographic system using paperboards according to Examples 1 and 2 and Comparative Example 1.

### DETAILED DESCRIPTION

### Outline of Exemplary Embodiment

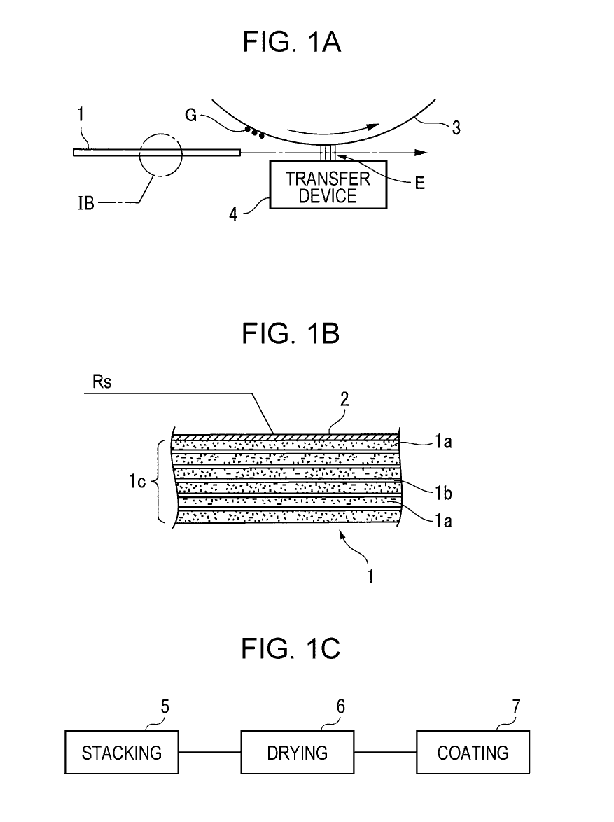

FIG. 1A shows an outline of an image forming method using a paperboard according to an exemplary embodiment to which the present invention is applied.

In FIG. 1A, the image forming method uses a multilayer paperboard 1 having predetermined surface electrical resistance Rs so that an image G formed by an electrophotographic system is electrostatically transferred to a surface serving as an image receiving surface of the paperboard 1.

In FIG. 1A, reference numeral 3 denotes an image holding member such as a photoconductor, a dielectric body, an intermediate transfer body, or the like, that holds an image formed by an electrophotographic system. In addition, reference numeral 4 denotes a transfer device 4 that applies a transfer electric field between the image holding member 3 and the paperboard 1 and electrostatically transfers the image G (using a single-color or multicolor toner as an image forming material in the electrophotographic system) on the image holding member 3 to an image forming surface of the paperboard 1.

The exemplary embodiment is suitable, as the paperboard 1, for a multilayer paperboard including plural stacked paper layers la as shown in FIG. 1B, and the surface electrical resistance Rs of the image forming surface in the electrophotographic system may be 1×10¹³Ω or less after humidity control in an environment of 20° C. and 10% RH.

In the technical method, “the paperboard 1” represents, in a broad sense, thick paper (a flat file, a wrapped package, a corrugated cardboard, a white paperboard, and the like). However, the exemplary embodiment is suitable for a multilayer paperboard including plural stacked paper layers 1a.

This is because the technical problem of the present invention occurs in the multilayer paperboard 1, while the technical problem is not found in the single-layer paperboard 1. The estimated reason for the technical problem in the multilayer paperboard 1 is that an insulating layer including an air layer 1b is interposed between the plural paper layers 1a. That is, the transfer efficiency caused by the action of transfer electric field E is uniquely determined by the transfer electric field E, but the transfer electric field E decreases as the paper thickness increases. In addition, the transfer electric field E is further decreased due to the insulating layers in the layer gaps (including the air layers 1b between the plural paper layers 1a), thereby decreasing the transfer efficiency. Further, it is estimated that in a low-humidity environment, the surface electrical resistance Rs is increased due to a lower moisture content in the paper layers (including the air layers between the paper layers), and thus the image G is insufficient in transfer performance.

Also, in the exemplary embodiment, a method for producing the paperboard 1 may be properly selected as long as the multilayer paperboard 1 can be produced.

Also, the surface electrical resistance Rs of the paperboard 1 is required to be 1×10¹³Ω or less after humidity control (in other words, humidity adjustment) in an environment of 20° C. and 10% RH (relative humidity).

When a surface of the paperboard 1 is used as an image forming surface in the electrophotographic system, it is necessary to satisfy the electrical resistance condition. Therefore, when one of the surfaces of the paperboard 1 is used as the image forming surface, the electrical resistance condition of only one of the surfaces may be controlled, while when both surfaces of the surfaces of the paperboard 1 are used as the image forming surfaces, the electrical resistance conditions of both surfaces are required to be controlled.

In the exemplary embodiment, when the surface electrical resistance Rs exceeds the upper limit described above, the surface electrical resistance Rs is excessively increased during use in a low-humidity environment, leading to deterioration in image quality.

Next, a typical configuration or desired configuration of the paperboard 1 used in the exemplary embodiment of the invention is described.

In the exemplary embodiment, the surface electrical resistance Rs of the image forming surface of the paperboard 1 in the electrophotographic system is desirably within a range of 1×10⁸Ω to 2×10¹⁰Ω at a moisture content of 6% to 8%.

In producing the paperboard 1, the surface electrical resistance Rs is selected at a predetermined moisture content, and the selection makes it easy to attain the condition of 1×10¹³Ω or less after moisture control in a low-humidity environment. When the surface electrical resistance Rs is lower than the lower limit, the surface electrical resistance Rs is decreased during use in a high-humidity environment. Accordingly, the transfer charge becomes insufficient, and a transfer defect easily occurs. Conversely, when the surface electrical resistance Rs exceeds the upper limit, the surface electrical resistance Rs cannot be sufficiently decreased during use in a low-humidity environment.

Also, the paperboard 1 used in the exemplary embodiment is desired to be a multilayer paperboard, and thus the lower limit of the basis weight of the paperboard 1 is often 200 g/m² or more. In addition, the upper limit of the basis weight of the multilayer paperboard 1 may be appropriately selected within the standards of a paper machine, and a paperboard having a basis weight of 465 g/m² or more has already been provided.

Further, a typical example of a structure of the paperboard 1 is configured to include plural paper layers 1a made by using paper raw materials and a conductive agent 2 applied to the paper layers 1a.

In this case, the surface electrical resistance condition of the paperboard 1 can be adjusted by controlling the type and amount of the conductive agent 2 added.

Further, an example of a typical form of the paperboard 1 is a flat file.

In this case, the paperboard 1 may be used as a flat file to be opened in a planar shape having a spine region between a front cover region and a back cover region and having a foldable crease which is shallower than a thickness dimension and which is formed between the spine region and each of the front cover region and the back cover region. In this example, the image G can be formed on the flat file by the electrophotographic system even in a low-moisture environment.

Also, in producing the paperboard 1 by stacking the plural paper layers la, as shown in FIGS. 1B and 1C, a typical example of a method for producing the paperboard 1 includes sequentially making the plural paper layers 1a by using paper raw materials and stacking the paper layers 1a, drying the resultant stack 1c formed by stacking, and coating a surface of the dried stack 1c with the conductive agent 2 so that the surface electrical resistance Rs of the image forming surface of the paperboard 1 in the electrophotographic system is 1×10¹³Ω or less after moisture control in the environment of 20° C. and 10% RH. In this example, the typical method includes stacking 5, drying 6, and coating 7. In this example, a desired surface characteristic is imparted to the stack 1c by the coating 7. In this case, the conductive agent 2 is applied for imparting a surface electrical resistance condition.

Further, in the method for producing the paperboard 1, the stacking 5, the drying 6, and the coating 7 are performed by using a cylinder paper machine, and the coating 7 is performed by a size press process in the cylinder paper machine. The cylinder paper machine is widely used for making the multilayer paperboard 1, and the coating 7 can be performed in a part of the size press process.

The present invention is described in further detail below on the basis of the exemplary embodiment shown in the attached drawings.

### Exemplary Embodiment

### —Configuration of Flat File—

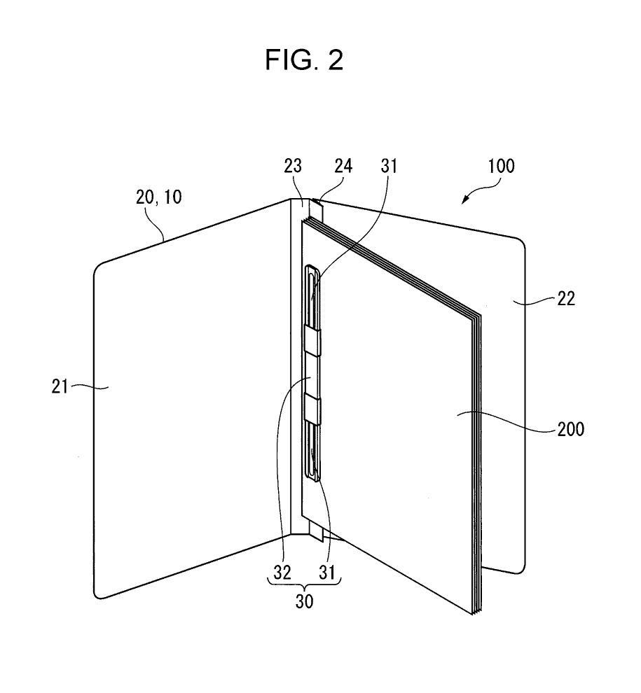

FIG. 2 shows a flat file 100 using the paperboard 1 according to an exemplary embodiment.

In FIG. 2, the flat file 100 includes a cover 20 on the inside of which documents 200 are bound together, and a binder 30 for binding the documents 200 on the inside of the cover 20.

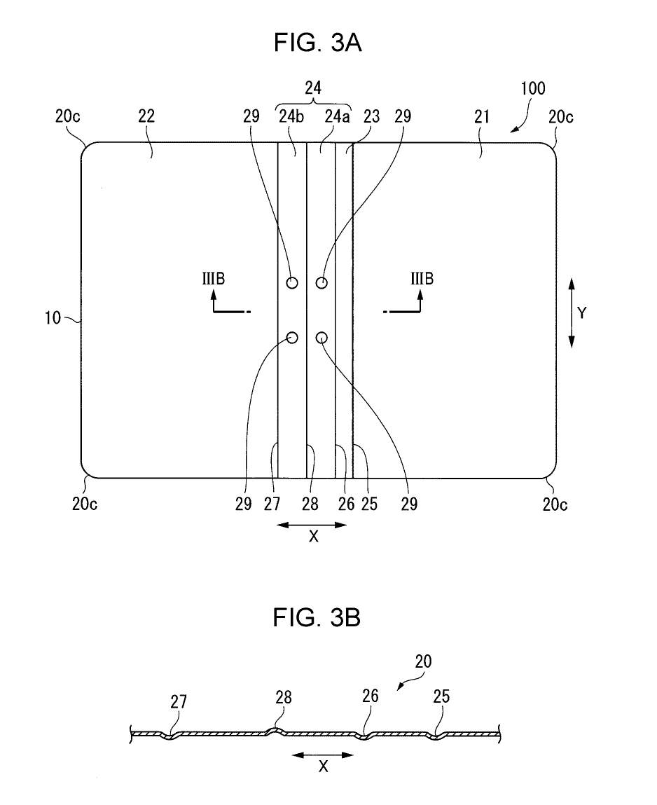

In this example, as shown in FIGS. 3A and 3B, the cover 20 includes a rectangular multilayer paperboard longer in the lateral direction (X direction) and when three-dimensionally formed, the cover 20 has a spine part 23 serving as a spine between a front cover part 21 serving as a front cover and a back cover part 22 serving as a back cover, and a binder holding part 24 that holds the binder 30. In addition, plural creases 25 to 28 foldable along the longitudinal direction (Y direction) are formed between the parts 21 to 24 and in a central portion of the binder holding part 24 in the X direction so that a three-dimensional shape shown in FIG. 2 is formed by folding the creases 25 to 28.

In addition, the binder 30 includes two binding bands 31 passed through holes (not shown) formed in the documents 200, and a press fitting 32 that fixes the documents 200 to the cover 20 by pressing the binding bands 31.

In the example, the four corners 20c of the cover 20 are provided with arc-like R-portions.

In the exemplary embodiment of the invention, the crease 25 is a crease which partitions between the front cover part 21 and the spine part 23, the crease 26 is a crease which partitions between the spine part 23 and the binder holding part 24, the crease 27 is a crease which partitions between the back cover part 22 and the binder holding part 24, and the crease 28 is a crease which partitions the central portion of the binder holding part 24 in the X direction. In this example, the creases 25, 26, and 27 are creases for so-called mountain folding which are foldable to project to the front side of the cover 20 as viewed on the paper of FIGS. 3A and 3B. On the other hand, the crease 28 is a crease for so-called valley folding which is foldable to recess to the back side of the cover 20 as viewed on the paper of FIGS. 3A and 3B.

In this example, the binder holding part 24 has a first binder holding part 24a adjacent to the spine part 23 and a second binder holding part 24b adjacent to the back cover part 22, the first and second binder holding parts 24a and 24b being symmetric with respect to the crease 28 as a boundary. In the three-dimensional shape shown in FIG. 2, the first and second binder holding parts 24a and 24b are folded at the crease 28, overlapped, and fixed in an overlapped state by using a double-sided tape or stapler.

Also, for example, two circular holding holes 29 are formed in each of the first and second binder holding parts 24a and 24b to as to align along the Y direction. The binder holding part 24 is arranged so that the holding holes 29 of one of the first and second binder holding parts 24a and 24b communicate with those of the other part in a state in which the first and second binder holding parts 24a and 24b are overlapped each other through the crease 28.

In addition, the binding bands 31 formed to have an end larger than the diameter of the holding holes 29 are passed through the respective holding holes 29 from the second binder holding part 24b side. The binding bands 31 passed through the holding holes 29 and projected from the first binder holding part 24a side are passed through binding holes (not shown) formed in the documents 200 and then pressed by the press fitting 32 of the binder 30. Consequently, the documents 200 are bound in the flat file 100.

### —Configuration Example of Paperboard—

A paperboard 10 used to configure the cover 20 of the flat file 100 according to the exemplary embodiment of the invention is as described below.

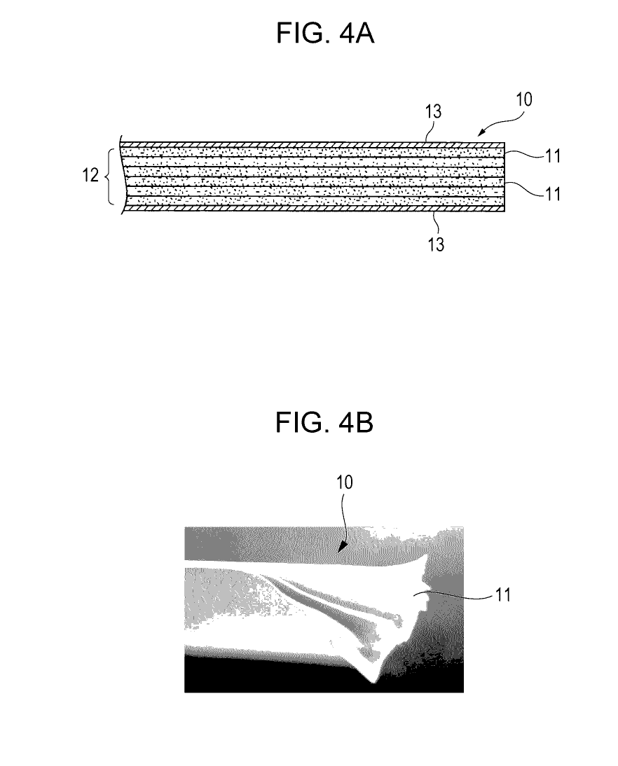

As shown in FIG. 4A, the paperboard 10 is configured in a multilayer form including plural (in this example, six) paper layers 11, which are made by using paper raw materials, and a conductive layer 13 formed by applying a conductive agent on the surfaces (in this example, both surfaces on the front side and back side of a stack 12) of the stack 12 including the plural paper layers 11.

The paperboard 10 used in this example has a basis weight of 200 g/m² or more, and the paperboard 10 having a basis weight of, for example, 250 to 465 g/m² is used according to application and the performance of a paper machine for producing the paperboard 10.

### <Paper Raw Material>

Examples of virgin chemical pulp (CP) used as a paper raw material include pulp produced by chemically treating wood or other fiber raw materials, such as leaf bleached kraft pulp (LBKP), needle bleached kraft pulp (NBKP), leaf unbleached kraft pulp (LUKP), needle unbleached kraft pulp (NUKP), leaf bleached sulfite pulp (LBSP), needle bleached sulfite pulp (NBSP), leaf unbleached sulfite pulp (LUSP), needle unbleached sulfite pulp (NUSP), soda pulp, and the like.

Other than the CP, virgin pulp such as mechanical pulp (MP) mechanically treated, chemiground pulp, chemo-mechanical pulp, semi-chemical pulp (SUP), or the like may be contained.

Further, examples of waste paper pulp which can be used include all kinds of waste paper pulp, such as waste paper pulp produced by disintegrating unprinted waste paper of high white, special white, medium white, or unprinted paper, which is waste paper produced by clipping, spoilage, or width cutting in bookbinding, a printing plant, a cutting plant, or the like; pulp (DIP) produced by disintegrating and then deinking waste paper of high-quality paper, high-quality coated payer, medium-quality paper, medium-quality coated paper, groundwood paper, or the like which is written by lithographic printing, letterpress printing, or gravure printing using a water-based ink, oil-based ink, or a pencil; and the like.

Further, examples of an internal sizing agent which can be used in the paper raw material include a rosin-based sizing agent, a synthetic sizing agent, a petroleum resin-based sizing agent, a neutral sizing agent, and the like. Also, the appropriate sizing agent can be used in combination with a fixing agent for the sizing agent and fibers, such as aluminum sulfate, cationized starch, or the like. In addition, the preparation and production conditions of raw materials are controlled for imparting electrophotographic applicability such as copy suitability, running performance, etc.

### <Conductive Agent>

Examples of the conductive agent which is used for forming the conductive layer 13 in the example include materials which can increase conductivity of paper, such as inorganic salts such as sodium chloride, sodium sulfate, potassium chloride, calcium chloride, sodium alginate, and the like, polymer electrolytes such as styrene-maleic acid copolymers, quaternary ammonium salts, and the like, organic acid salts such as potassium formate, sodium bromate, and the like, surfactants such as soaps, phosphate salts, carboxylate salts, and the like, electronically conductive materials such as aluminum oxide-doped zinc oxide, antimony-doped tin oxide, titanium oxide, and the like.

### —Resistance Characteristic of Paper—

Examination of a relation between the moisture content (equilibrium moisture) and surface electrical resistance of paper as a resistance characteristic of paper generally shows the tendency that the surface electrical resistance of paper decreases with increases in the equilibrium moisture content. In this case, when an image is formed by the electrophotographic system using plain paper, even with an increase in surface electrical resistance of the paper due to a decrease in equilibrium moisture content, the density of the image electrostatically transferred to the paper is slightly decreased, but an extreme decrease in the density is not found.

On the other hand, when an image is formed by the electrophotographic system using the multilayer paperboard 10 as paper, with an increase in surface electrical resistance of the paper due to a decrease in equilibrium moisture content, the density of the image electrostatically transferred to the paper is extremely decreased, and the phenomenon of much generating image omission is found.

Therefore, in the exemplary embodiment, attention is given to the multilayer paperboard 10 as paper, and the surface electrical resistance of the paper is adjusted so that deterioration (density decrease and image omission) of an image electrostatically transferred to the paper does not occur in an environment (low-humidity environment) in which the equilibrium moisture content of the paper is decreased.

In the exemplary embodiment, the conclusion obtained is that characteristics described below are required as the resistance characteristics of the paperboard 10. In the exemplary embodiment, the type and amount of the conductive agent added for forming the conductive layer 13 which coats the surface of the paperboard 10 are selected so that the surface electrical resistance Rs of the paperboard 10 is within a range below.

(1) The surface electrical resistance Rs of the paperboard 10 is 1×10⁸ to 2×10¹⁰Ω at a moisture content of 6% to 8%.

(2) The surface electrical resistance Rs of the paperboard 10 is 1×10¹³Ω or less after moisture control in an environment of 20° C. and 10% RH.

In the exemplary embodiment, the surface electrical resistance Rs of the paperboard 10 is measured according to JIS K 6911, and the moisture content of paper is measured according to JIS P 8127.

The details are described in detail in examples below.

### —Example of Method for Producing Paperboard—

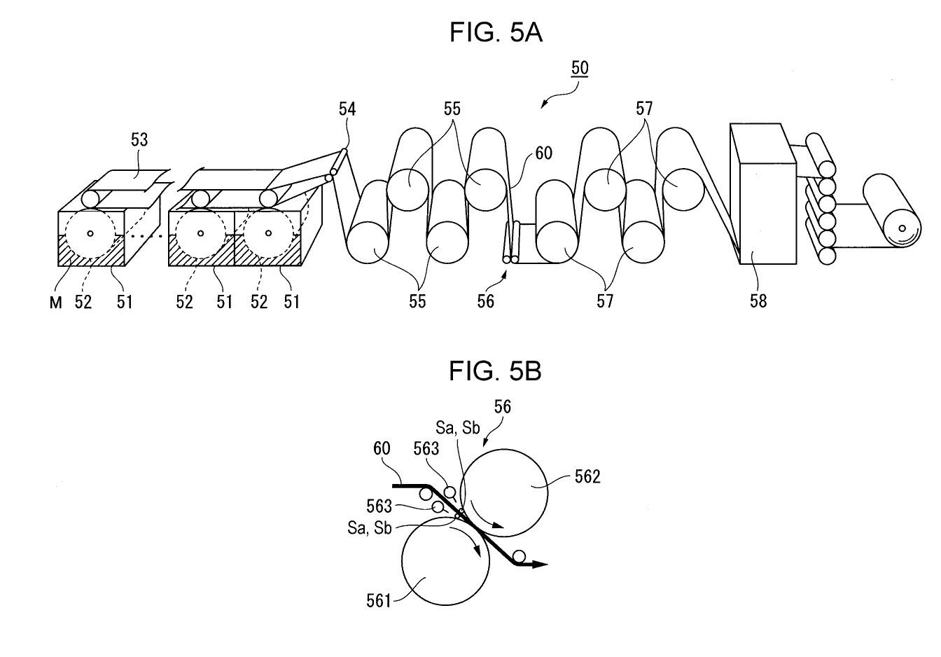

In the example, the paperboard 10 is produced by a paper machine 50 shown in FIG. 5A.

In FIG. 5A, a cylinder paper machine is used as the paper machine 50.

In the example, the paper machine 50 includes a cylinder 52 rotatably installed in each of plural baths 51 which contain paper raw materials M (pulp and chemicals such as a sizing agent added). Among the paper raw materials M, water flows into the inside through the mesh of each of the cylinders 52, and only paper is sequentially attached to the surfaces of the cylinders 52.

Next, in the paper machine 50, the paper layers attached to the respective cylinders 52 are held in a stacked state on a conveyance body 53 such as a blanket, and then water is squeezed out by a squeezing roller 54. Then, the resultant paper stack 60 is attached to multi-stage rotating drying cylinders 55 and dried. Then, when, as shown in FIG. 5B, the thickness of the paper stack 60 is adjusted by a size press 56, a conductive agent Sa and another necessary additive Sb (for example, starch) are applied to the surfaces of the paper stack 60. The conductive agent Sa etc. are dried by attaching the paper stack 60 to multi-stage rotating drying cylinders 57 and then post-treatment (treatment to adjust the temperature, gloss, thickness, flexibility, shrinkage change prevention, and the like of paper) is performed by using a post-treatment device 58. Then, the treated multilayer paperboard is taken up or cut into a planar shape and then discharged.

As shown in FIG. 5B, an example of the size press used in the example is a two-roll size press including a pair of pressure rolls 561 and 562 for pressure conveyance and coating agent supply parts 563 provided between the pressure roll 561 and the paper stack 60 and between the pressure roll 562 and the paper stack 60 so as to apply coating agents such as the conductive agent Sa, the additive Sb, and the like. Also, a gate roll-type size press or a metaling size press using a blade or rod may be used as another coating device.

### —Method for Forming Image on Flat File—

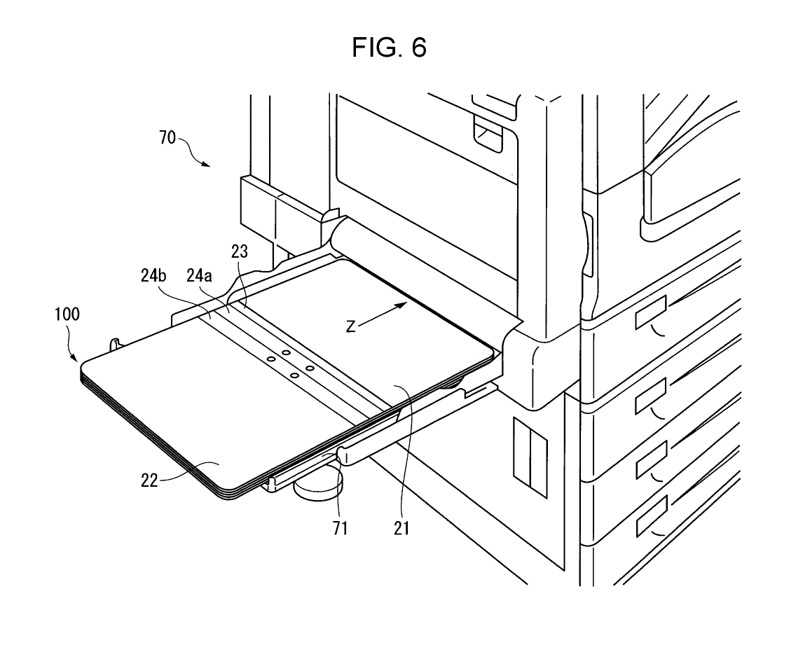

FIG. 6 shows an image forming apparatus 70 having the function of printing image information such as characters of a sentence and the like in a state in which plural planar flat files 100 are stacked and set on a manual feed tray 71. In FIG. 6, Z denotes a direction in which the flat files 100 on the manual feed tray 71 are drawn into the image forming apparatus 70.

In the example, the image forming apparatus 70 has an image forming engine (not shown) using the electrophotographic system in which, for example, a color component image is formed on, for example, a photoconductor in an image forming part of each of the color components (yellow Y, magenta M, cyan C, and black K). The color component image on each of the photoconductors is first transferred to an intermediate transfer body and then second transferred to a recording medium such as paper or the like.

In the example, for example, the flat files 100 packed in a sealed state are opened, then set on the manual feed tray 71, and left as they are for a while. Consequently, the flat files 100 on the manual feed tray 71 are put into an environmental condition according to the position where the image forming apparatus 70 is installed.

In this case, for example, even when the moisture content of the flat files 100 at packaging is 6 to 8%, standing for a long time in a low-humidity environment of 20° C. and 10% RH inevitably causes the state of decreasing the moisture content.

Therefore, in the exemplary embodiment, even when the flat files 100 are subjected to moisture control in a low-humidity environment, the surface electrical resistance Rs of the cover 20 of the flat file 100 is adjusted to be 1×10¹³Ω or less.

### Modified Embodiment

In this example, a paperboard having predetermined resistance characteristics is used for the flat file 100, and the cover 20 of the flat file 100 has a front cover part 21, a back cover part 22, a spine part 23, and a binder holding part 24. However, the cover 20 may include at least the front cover part 21 and the back cover part 22 and may not include the spine part 23 and the binder holding part 24. In this example, the cover 20 of the flat file 100 is entirely configured by a single type of multilayer paperboard. However, the configuration is not limited to this, and the paperboard may contain a sheet made of a transparent resin material as a part of the paperboard.

Further, although this example uses the paperboard for the flat file 100, the paperboard may be used for things other than the flat file 100.

For example, the paperboard may be used for forming a box (only a housing part or a lid part of the box) as an example of a packaging container.

The paperboard used for forming a box as a packaging container has plural creases previously formed in the longitudinal direction, the lateral direction, and the diagonal direction so that the paperboard is folded along the creases to form a three-dimensional box. When the paperboard of this example is used in printing a portion of the paperboard, which is used as a surface of the box, by an image forming apparatus, the quality of an image formed by the electrophotographic system using the image forming apparatus can be maintained good.

### EXAMPLES

### Example 1

First, 50% of needle bleached kraft pulp (NBKP) and 50% of leaf bleached kraft pulp (LBKP) are mixed. Then, a rosin-based sizing agent is added as an internal sizing agent at a ratio of 0.2% to the pulp weight. By using the resultant paper raw material, 6 layers of 50 g/m² each are formed by a cylinder paper machine and then coated by size pressing treatment so that an amount of starch is 1 g/m² and an amount of sodium chloride is 0.5 g/m², thereby producing a paperboard with a basis weight of 300 g/m².

The copy image quality of the paperboard in a low-humidity environment is confirmed as follows. The paperboard is allowed to stand for 2 hours in an environment of 20° C. and 10% RH, and then the image density and image omission are confirmed by printing a blue image on a single side using a multifunction machine (ApeosPrt V C5576, manufactured by Fuji Xerox Co., Ltd.).

### Example 2

First, 50% of needle bleached kraft pulp (NBKP) and 50% of leaf bleached kraft pulp (LBKP) are mixed. Then, a rosin-based sizing agent is added as an internal sizing agent at a ratio of 0.2% to the pulp weight. By using the resultant paper raw material, 5 layers of 60 g/m² each are formed by a cylinder paper machine and then coated by size pressing treatment so that an amount of starch is 1 g/m² and an amount of sodium sulfate is 1.0 g/m², thereby producing a paperboard with a basis weight of 300 g/m².

The copy image quality of the paperboard in a low-humidity environment is confirmed by the same method as in Example 1.

### Example 3

First, 50% of needle bleached kraft pulp (NBKP) and 50% of leaf bleached kraft pulp (LBKP) are mixed in each of a front surface layer (first layer) ad a back surface layer (fifth layer), and 100% of pulp produced by disintegrating and deinking magazine waste paper is mixed in each of the intermediate layers (second, third, and fourth layers). Then, a rosin-based sizing agent is added as an internal sizing agent at a ratio of 0.2% to the pulp weight. By using the resultant paper raw material, 5 layers of 60 g/m² each are formed by a cylinder paper machine and then coated by size pressing treatment so that an amount of starch is 1 g/m² and an amount of sodium chloride is 0.6 g/m², thereby producing a paperboard with a basis weight of 300 g/m².

The copy image quality of the paperboard in a low-humidity environment is confirmed by the same method as in Example 1.

### Example 4

First, 50% of needle bleached kraft pulp (NBKP) and 50% of leaf bleached kraft pulp (LBKP) are mixed. Then, a rosin-based sizing agent is added as an internal sizing agent at a ratio of 0.2% to the pulp weight. By using the resultant paper raw material, 6 layers of 45 g/m² each are formed by a cylinder paper machine and then coated by size pressing treatment so that an amount of starch is 1 g/m² and an amount of sodium chloride is 0.7 g/m², thereby producing a paperboard with a basis weight of 270 g/m².

The copy image quality of the paperboard in a low-humidity environment is confirmed by the same method as in Example 1.

### Comparative Example 1

First, 50% of needle bleached kraft pulp (NBKP) and 50% of leaf bleached kraft pulp (LBKP) are mixed. Then, a rosin-based sizing agent is added as an internal sizing agent at a ratio of 0.2% to the pulp weight. By using the resultant paper raw material, 6 layers of 50 g/m² each are formed by a cylinder paper machine and then coated by size pressing treatment so that an amount of starch is 1 g/m², thereby producing a paperboard with a basis weight of 300 g/m².

The copy image quality of the paperboard in a low-humidity environment is confirmed by the same method as in Example 1.

### Comparative Example 2

First, 100% of leaf bleached kraft pulp (LBKP) is mixed. Then, an ASA (alkenyl succinic anhydride) sizing agent is added as an internal sizing agent at a ratio of 0.2% to the pulp weight. By using the resultant paper raw material, 1 layer is formed by a Foundrinier paper machine and then coated by size pressing treatment so that an amount of starch is 1 g/m² and an amount of sodium chloride is 0.15 g/m², thereby producing paper with a basis weight of 64 g/m².

The copy image quality of the paperboard in a low-humidity environment was confirmed by the same method as in Example 1.

### Comparative Example 3

First, 20% of needle bleached kraft pulp (NBKP) and 80% of leaf bleached kraft pulp (LBKP) are mixed. Then, an ASA sizing agent is added as an internal sizing agent at a ratio of 0.2% to the pulp weight. By using the resultant paper raw material, 1 layer is formed by a Foundrinier paper machine and then coated by size pressing treatment so that an amount of starch is 1 g/m² and an amount of sodium chloride is 0.25 g/m², thereby producing paper with a basis weight of 300 g/m².

The copy image quality of the paper in a low-humidity environment is confirmed by the same method as in Example 1.

—Relation between Equilibrium Moisture and Surface Electrical Resistance of Paperboard—

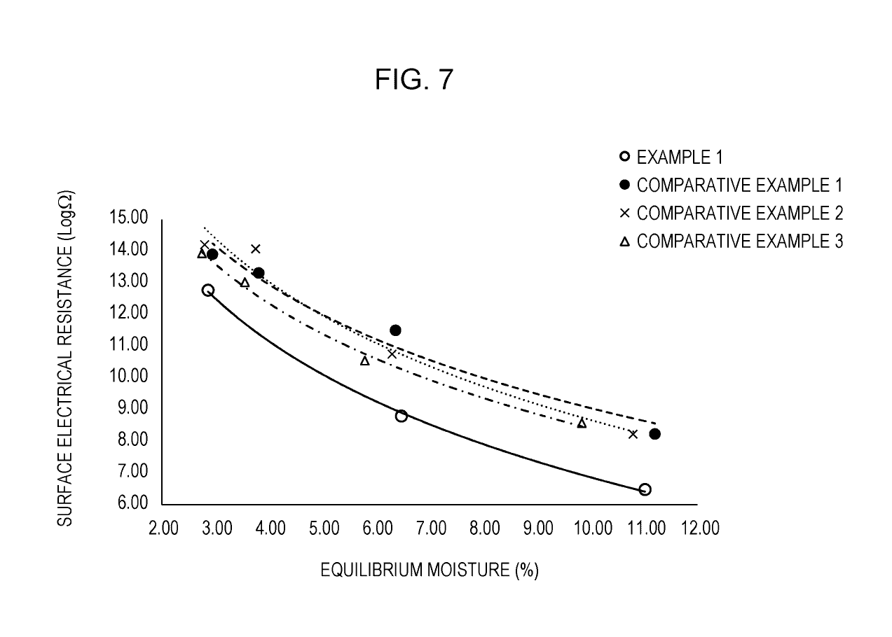

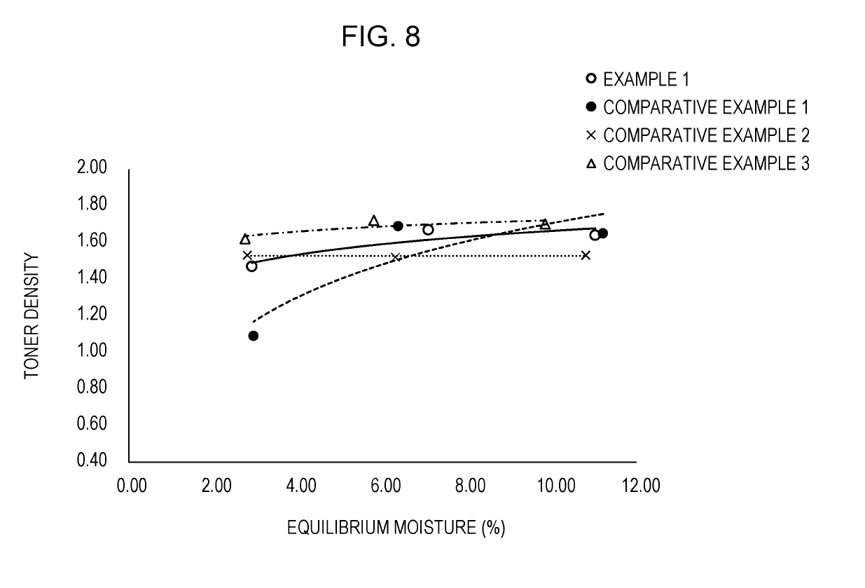

A relation between the moisture (equilibrium moisture) content and surface electrical resistance of the paperboard or paper in each of Example 1 and Comparative Examples 1 to 3 is examined. The results obtained are shown in FIG. 7.

Both Example 1 and Comparative Example 1 show the tendency that the surface electric resistance Rs decreases as the equilibrium moisture content increases, and conversely the surface electric resistance Rs increases as the equilibrium moisture content decreases. However, it is understood that a difference in surface electrical resistance Rs between Example 1 and Comparative Example 1 depends on the presence of the conductive agent.

Also, Comparative Examples 2 and 3 are both single-layer paper, but show substantially the same tendency as Example 1 and Comparative Example 1. However, it is understood that the basis weight of paper of Comparative Example 3 is substantially the same as that of Example 1, but the surface electrical resistance Rs of Comparative Example 3 is slightly higher than that of Example 1.

### —Relation Between Equilibrium Moisture and Toner Density of Paperboard—

It is understand from comparison between Example 1 and Comparative Example 1 that in Comparative Example 1 (multilayer paperboard without the conductive layer), the toner density tends to decrease as the equilibrium moisture content decreases, while in Example 1 (multilayer paperboard including the conductive layer), a decrease in toner density is suppressed even when the equilibrium moisture content is decreased.

On the other hand, in Comparative Examples 2 and 3, the tendency (the toner density decreases with decreases in equilibrium moisture) as in Comparative Example 1 is not found, and the toner density is not remarkably decreased even when the equilibrium moisture content is decreased.

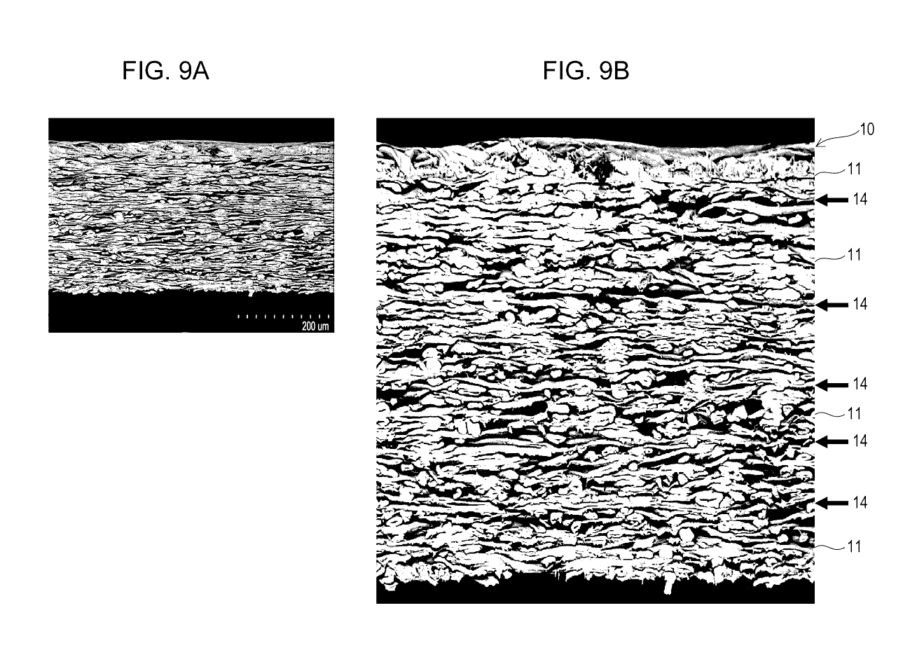

Therefore, as described above, the configuration of Comparative Example 1 (multilayer paperboard without the conductive layer) causes the phenomenon that the toner density decreases in a low-humidity environment with a decrease in equilibrium moisture content. The supposed cause for this is that as shown in FIGS. 9A and 9B, the multilayer paperboard is put into a condition in which insulating layers each including an air layer 14 are interposed between the paper layers 11, and thus when a second transfer electric field is applied, for example, between the intermediate transfer body and the paperboard in the electrophotographic system, the surface electrical resistance Rs of the paperboard of Comparative Example 1 is increased, thereby causing an image transfer defect and accordingly leading to decrease in the toner density.

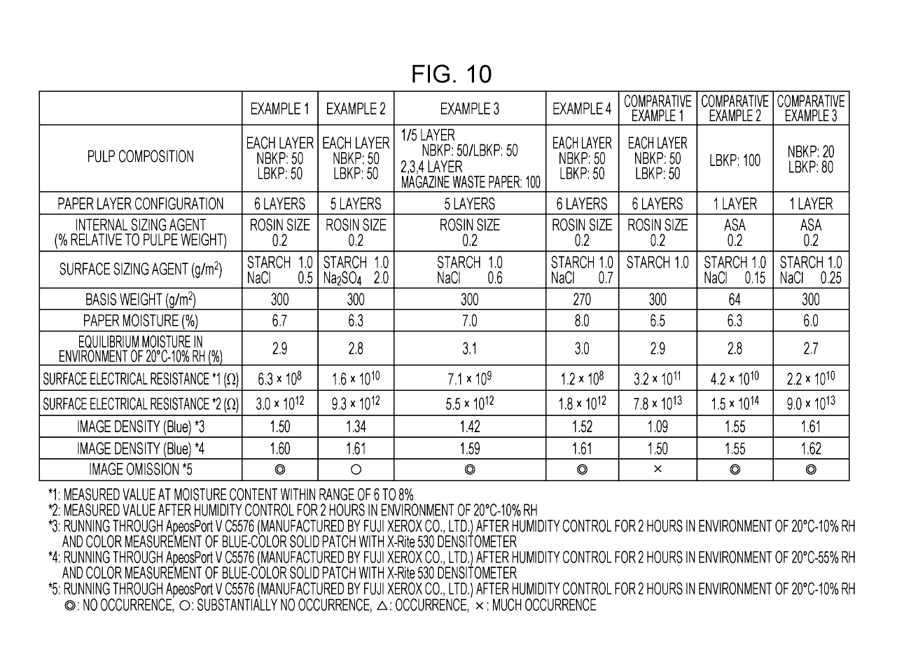

FIG. 10 shows the physical properties, characteristics, and image quality evaluation of the paperboards of Examples 1 to 4 and Comparative Examples 1 to 3.

According to FIG. 10, in Example 1, as a result of measurement of the equilibrium moisture content of the paperboard after humidity control for 2 hours in an environment of 20° C. and 10% RH, the equilibrium moisture content is 2.9%, and the surface electrical resistance is 3.0×10¹²Ω. Also, the surface electrical resistance at a moisture content of 6.7% is 6.3×10⁸Ω.

With respect to copy image quality, it is confirmed that the image density is sufficient, and no image omission occurs.

Therefore, it is supported by Example 1 that when the surface electrical resistance of the paperboard is controlled to 3.0×10¹²Ω in the environment of 20° C. and 10% RH, the effect is to produce a paperboard without image deterioration after low-humidity control.

Also, in Example 2, as a result of measurement of the equilibrium moisture content of the paperboard after humidity control for 2 hours in an environment of 20° C. and 10% RH, the equilibrium moisture content is 2.8%, and the surface electrical resistance is 9.3×10¹²Ω. Also, the surface electrical resistance at a moisture content of 6.3% is 1.6×10¹⁰Ω.

With respect to copy image quality, it is confirmed that the image density is sufficient, and substantially no image omission occurs.

Therefore, it is supported by Example 2 that when the surface electrical resistance of the paperboard is controlled to 9.3×10¹²Ω in the environment of 20° C. and 10% RH, the effect is to produce a paperboard with substantially no image deterioration after low-humidity control.

Further, in Example 3, as a result of measurement of the equilibrium moisture content of the paperboard after humidity control for 2 hours in an environment of 20° C. and 10% RH, the equilibrium moisture content is 3.1%, and the surface electrical resistance is b 5.5×10¹²Ω. Also, the surface electrical resistance at a moisture content of 7.0% is 7.1×10⁹Ω.

With respect to copy image quality, it is confirmed that the image density is sufficient, and no image omission occurs.

Therefore, it is supported by Example 3 that when the surface electrical resistance of the paperboard is controlled to 5.5×10¹²Ω in the environment of 20° C. and 10% RH, the effect is to produce a paperboard without image deterioration after low-humidity control.

Further, in Example 4, as a result of measurement of the equilibrium moisture content of the paperboard after humidity control for 2 hours in an environment of 20° C. and 10% RH, the equilibrium moisture content is 3.0%, and the surface electrical resistance is 1.8×10¹²Ω. Also, the surface electrical resistance at a moisture content of 8.0% is 1.2×10⁸Ω.

With respect to copy image quality, it is confirmed that the image density is sufficient, and no image omission occurs.

Therefore, it is supported by Example 4 that when the surface electrical resistance of the paperboard is controlled to 1.8×10¹²Ω in the environment of 20° C. and 10% RH, the effect is to produce a paperboard without image deterioration after low-humidity control.

On the other hand, in Comparative Example 1, as a result of measurement of the equilibrium moisture content of the paperboard after humidity control for 2 hours in an environment of 20° C. and 10% RH, the equilibrium moisture content is 2.9%, and the surface electrical resistance is 7.8×10¹³Ω. Also, the surface electrical resistance at a moisture content of 6.5% is 3.2×10¹¹Ω.

With respect to copy image quality, it is confirmed that the image density is low, and image omission much occurs.

Also, in Comparative Example 2, as a result of measurement of the equilibrium moisture content of the paper after humidity control for 2 hours in an environment of 20° C. and 10% RH, the equilibrium moisture content is 2.8%, and the surface electrical resistance is 1.5×10¹⁴Ω. Also, the surface electrical resistance at a moisture content of 6.3% is 4.2×10¹⁰Ω.

However, with respect to copy image quality, neither decrease in the image density nor image omission is found.

Further, in Comparative Example 3, as a result of measurement of the equilibrium moisture content of the paper after humidity control for 2 hours in an environment of 20° C. and 10% RH, the equilibrium moisture content is 2.7%, and the surface electrical resistance is 9.0×10¹³Ω. Also, the surface electrical resistance at a moisture content of 6.0% is 2.2×10¹⁰Ω.

However, with respect to copy image quality, neither decrease in the image density nor image omission is found.

Thus, it is understood that the configuration of the multilayer paperboard of Comparative Example 1 causes deterioration in image quality after low-humidity control and that Examples 1 to 4 are effective.

It is further understood that although, unlike Comparative Example 1, the single-layer paper of Comparative Examples 2 and 3 causes no deterioration in image quality after low-humidity control, the surface electrical resistance after humidity control in the environment of 20° C. and 10% RH exceeds 1×10¹³Ω, and in Comparative Examples 2 and 3, the surface electrical resistance at a moisture content of 6.0% to 8% is out of the range of 1×10⁸Ω to 2 ×10¹⁰Ω.

### [Evaluation of Image Quality]

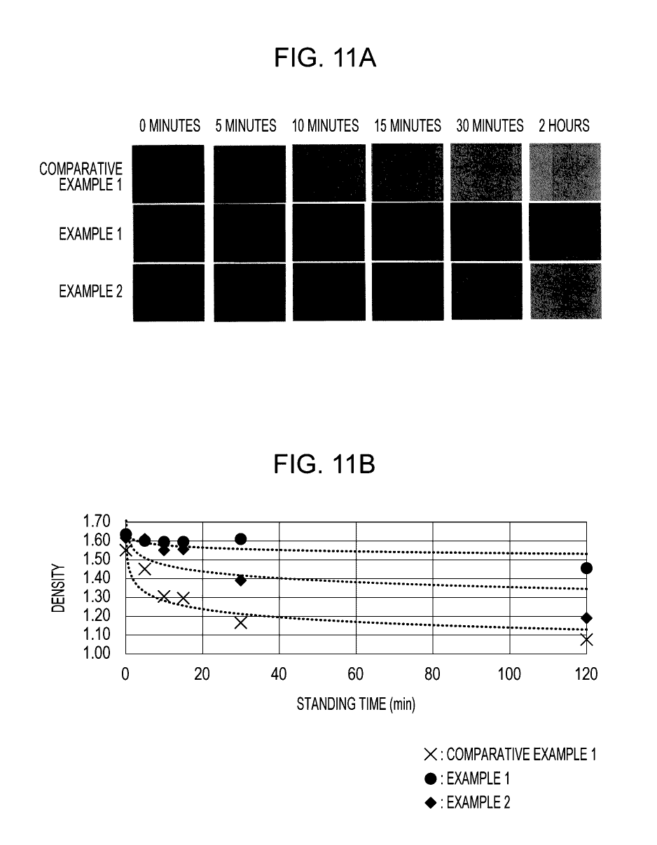

Each of the paperboards of Examples 1 and 2 and Comparative Example 1 is set in the manual feed tray of the multifunction machine (ApeosPrt V C5576, manufactured by Fuji Xerox Co., Ltd.) in the environment of 20° C. and 10% RH. Then, the paperboard is allowed to stand for 5 minutes, 10 minutes, 15 minutes, 30 minutes, and 2 hours (complete humidity control) and subjected to single-side printing. Evaluation of the image density and image omission produces the results shown in FIGS. 11A and 11B.

FIG. 11A shows a monochrome display of a halftone secondary-color image (using a secondary color of magenta toner and cyan toner) sample of each of Examples 1 and 2 and Comparative Example 1, and FIG. 11B shows the plots of changes in the image density with the passage of the standing time.

It is confirmed by FIGS. 11A and 11B that in Example 1, substantially neither decrease in the image density nor image omission occurs with the passage of the standing time, while in Example 2, the image density slightly decreases with the passage of the standing time as compared with Example 1, but the image density decreases in a small degree, and substantially no image omission occurs. Also, it is understood that in Comparative Example 1, decreases in the image density and image omission occur with the passage of the standing time.

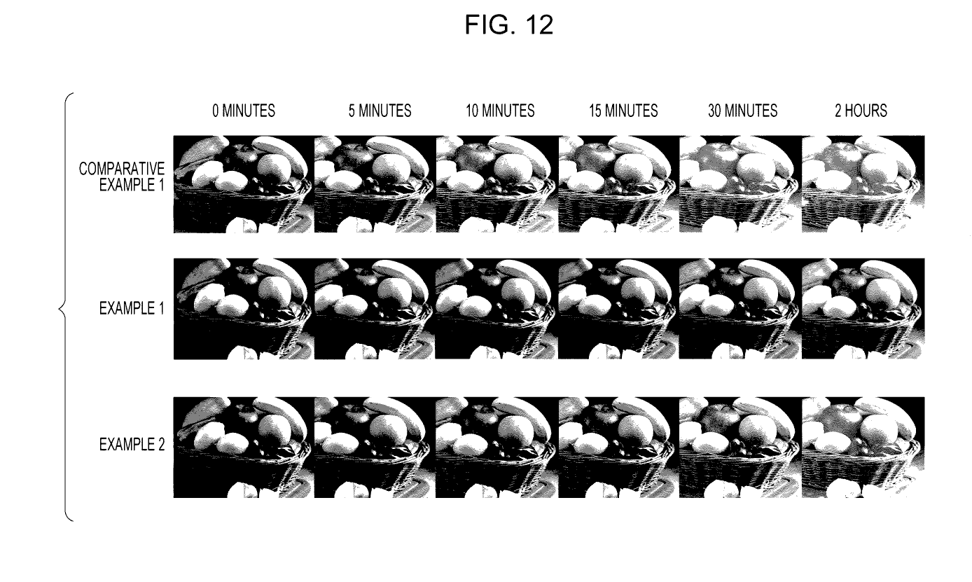

Further, FIG. 12 shows a monochrome display of a full-color image sample of each of Examples 1 and 2 and Comparative Example 1. It is confirmed that in Examples 1 and 2, substantially neither decrease in image density nor image omission occurs with the passage of the standing time. Also, it is understood that in Comparative Example 1, decrease in the image density and image omission occur with the passage of the standing time.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A paperboard comprising a plurality of stacked paper layers,
wherein the surface electrical resistance of an image forming surface by an electrophotographic system is 1×10¹³Ω or less after humidity control in an environment of 20° C. and 10% RH.

2. The paperboard according to claim 1, wherein the surface electrical resistance of the image forming surface by the electrophotographic system is within a range of 1×10⁸Ω to 2×10¹⁰Ω at a moisture content of 6% to 8%.

3. The paperboard according to claim 1, wherein the basis weight is 200 g/m² or more.

4. The paperboard according to claim 1 comprising:
a plurality of paper layers made by using a paper raw material; and
a conductive agent applied to a surface of the paper layers.

5. The paperboard according to claim 1, wherein the paperboard is used as a flat file to be opened in a planar shape having a spine region between a front cover region and a back cover region, and foldable creases shallower than a thickness dimension are formed between the spine region and the front cover region and between the spine region and the back cover region.

6. A method for producing a paperboard including a plurality of stacked paper layers, the method comprising:
sequentially forming a plurality of paper layers using a paper raw material and stacking the plurality of paper layers;
drying a stack produced by the stacking; and
coating the stack with a conductive agent after the drying so that the surface electrical resistance of an image forming surface of the paperboard in an electrophotographic system is 1×10¹³Ω or less after humidity control in an environment of 20° C. and 10% RH.

7. The method according to claim 6, wherein the stacking, the drying, and the coating are performed with a cylinder paper machine, and the coating is performed in a size press process in the cylinder paper machine.

8. An image forming method comprising:
forming an image by an electrophotographic system; and
electrostatically transferring the image to a surface serving as an image receiving surface of a paperboard including a stack of a plurality of paper layers, the surface electrical resistance of the stack being 1×10¹³Ω or less after humidity control in an environment of 20° C. and 10% RH.
